(19) United States
(12) Patent Application Publication
(10) Pub. No.: US 2015/0030405 A1
(43) Pub. Date: Jan. 29, 2015

(54) CONTROL METHOD OF MACHINE TOOL AND MACHINE TOOL

(71) Applicant: MITSUBISHI HEAVY INDUSTRIES, LTD., Tokyo (JP)

(72) Inventors: Megumu Tsuruta, Tokyo (JP); Naotaka Komatsu, Tokyo (JP); Katsuyoshi Takeuchi, Tokyo (JP); Takashi Shibutani, Tokyo (JP); Satoshi Furutate, Tokyo (JP)

(73) Assignee: MITSUBISHI HEAVY INDUSTRIES, LTD., Tokyo (JP)

(21) Appl. No.: 14/384,620

(22) PCT Filed: Mar. 21, 2013
(86) PCT No.: PCT/JP2013/058125

§ 371 Date: Sep. 11, 2014

(30) Foreign Application Priority Data
Mar. 29, 2012 (JP) 2012-075735

(51) Int. Cl. B23Q 15/007

(52) U.S. Cl. CPC B23Q 15/007
USPC 409/80

(57) ABSTRACT

A machine tool includes a machine tool main body, a ram which is supported with respect to the machine tool main body in a movable manner, a main shaft which is supported by the ram in a drivable and rotatable manner, an attachment which can be attached to and detached from a tip end portion of the ram and includes a driving shaft rotated according to rotation of the main shaft and a tool provided on the driving shaft, and a NC device which performs a numerical control based on machining data, and performs machining of a processing target. The control method of a machine tool includes a step of decreasing at least one of a ram overhang amount or a feeding amount when stress applied to the attachment is larger than allowable stress of the attachment based on a machining condition including a diameter, a depth of cut, and a feeding amount of the tool, and information including the ram overhang amount, a shape of the attachment, and a material of the processing target.

### TECHNICAL FIELD

The present invention relates to a control method of a machine tool having an attachment and a machine tool, and particularly, to a control method of a machine tool and a machine tool capable of preventing damage to an attachment. Priority is claimed on Japanese Patent Application No. 2012-075735, filed Mar. 29, 2012, the content of which is incorporated herein by reference.

### BACKGROUND ART

In the related art, in a machine tool which machines a processing target, a configuration is known, in which an attachment having a cutting tool for machining or the like can be attached to and detached from a machine tool main body. The attachment includes a structure which can rotate the tool for machining or can change a direction of the tool in accordance with a shape of the processing target (for example, refer to PTL 1).

The attachment corresponds to various machining patterns. However, the attachment is likely to be operated in an operation condition which exceeds a strength limit of a member configuring the attachment due to a stiffness change in magnitude of an overhang amount of the tool, a cutting resistance change due to differences in machining conditions, a moment change, or the like, and is likely to be damaged.

In addition, according to an increase in cutting resistance, a mounting position of the attachment is deviated, and thus, quality of a machined surface is degraded.

Moreover, by combination of the magnitude of the overhang amount, the stiffness change due to a backlash element, or machining conditions (magnitude, direction, frequency or the like of cutting resistance), chatter vibration occurs in the attachment. As a result, a decrease in the quality of the machined surface may occur, or machining may not be performed under the conditions.

In a machine tool disclosed in PTL 2, a damper is provided on a ram stock to which an attachment is attached, and thus, a decrease in tool vibration is promoted by adjusting the natural frequency of the damper.

### CITATION LIST

### Patent Literature

[PTL 1] Japanese Unexamined Patent Application Publication No. 6-304843

[PTL 2] Japanese Unexamined Patent Application Publication No. 2009-190141

### SUMMARY OF INVENTION

### Technical Problem

However, in the machine tool disclosed in PTL 2, it is necessary to additionally install an adjustment mechanism or a drive source, and thus, there is a problem in that an increase in the size of an apparatus and an increase in cost occur.

The present invention is to provide a control method of a machine tool and a machine tool which prevent damage to an attachment without additionally installing a new mechanism.

### Solution to Problem

According to a first aspect of the present invention, there is provided a control method of a machine tool which includes: a machine tool main body; a ram which is supported with respect to the machine tool main body in a movable manner; a main shaft which is supported by the ram in a drivable and rotatable manner; an attachment which can be attached to and detached from a tip end portion of the ram and includes a driving shaft rotated according to rotation of the main shaft and a tool provided on the driving shaft; and an NC device which performs a numerical control based on machining data, and performs machining of a processing target, including: a step of decreasing at least one of a ram overhang amount or a feeding amount when stress applied to the attachment is larger than allowable stress of the attachment based on a machining condition including a diameter, a depth of cut, and a feeding amount of the tool, and information including the ram overhang amount, a shape of the attachment, and a material of the processing target.

Accordingly, when the stress applied to the attachment is larger than the allowable stress, the machining condition is alleviated, the cutting resistance is decreased, and thus, damage to the attachment can be prevented. Moreover, adjustment of the machining condition is automatically performed during machining without using cutting for testing or the like, and thus, it is possible to improve productivity. In addition, since the control method is realized by simply changing the control method without additional mechanical portions, it is possible to prevent damage to the attachment at a low cost.

The control method of the machine tool, may further include a step of decreasing at least one of the ram overhang amount or the feeding amount when the stress, which is applied to the attachment and calculated from a function among cutting resistance calculated from the product of the diameter of the tool, the feeding amount, and a specific cutting resistance of the material of the processing target, the ram overhang amount, and a cross-sectional secondary moment calculated by the shape of the attachment, is larger than the allowable stress of the attachment.

The control method of the machine tool, may further include a step of changing a rotation speed of the main shaft when frequency of the cutting resistance calculated by the rotation speed of the main shaft and the number of cutting teeth of the tool is equal to resonance frequency of the attachment calculated by the shape of the attachment.

According to the configuration, the frequency of the cutting resistance and the resonance frequency of the attachment are made different from each other by changing the rotation speed of the main shaft, and thus, it is possible to prevent occurrence of chattering by simply changing the control method.

According to a second aspect of the present invention, there is provided a machine tool including a control device which performs the control method of the machine tool in any of the above-mentioned.

The machine tool may further include solid identification means which is provided on the attachment and stores shape information regarding the attachment; and a solid identification information receiving unit which is provided on the ram and receives information from the solid identification means, in which the attachment may be attached to the ram, and thus, the shape information regarding the attachment may be sent to the control device and the NC device.

According to the configuration, information regarding a mechanical element configuring the attachment is input to the solid identification means, the information is sent to the NC device or the control device by only attaching the attachment to the ram, and thus, it is not necessary to switch the information regarding the attachment by the operation of an operator.

### Advantageous Effects of Invention

According to the present invention, when stress applied to an attachment is larger than the allowable stress, a machining condition is alleviated, cutting resistance is decreased, and thus, damage to the attachment can be prevented. Moreover, adjustment of the machining condition is automatically performed during machining without using cutting for testing or the like, and thus, it is possible to improve productivity. In addition, since the control method is realized by only simply the control method without additional mechanical portions, it is possible to prevent damage to the attachment at a low cost.

### BRIEF DESCRIPTION OF DRAWINGS

FIG. 1 is a schematic perspective view of a machine tool according to a first embodiment of the present invention.

FIG. 2 is a cross-sectional view showing a ram and an attachment of the machine tool.

FIG. 3 is a flowchart explaining a control method of the machine tool.

FIG. 4 is a graph in which a cutting resistance adjustment function is referred to.

FIG. 5 is a cross-sectional view showing a ram and an attachment of a machine tool according to a second embodiment of the present invention.

### DESCRIPTION OF EMBODIMENTS

### First Embodiment

Hereinafter, a first embodiment of the present invention will be described in detail with reference to the drawings.

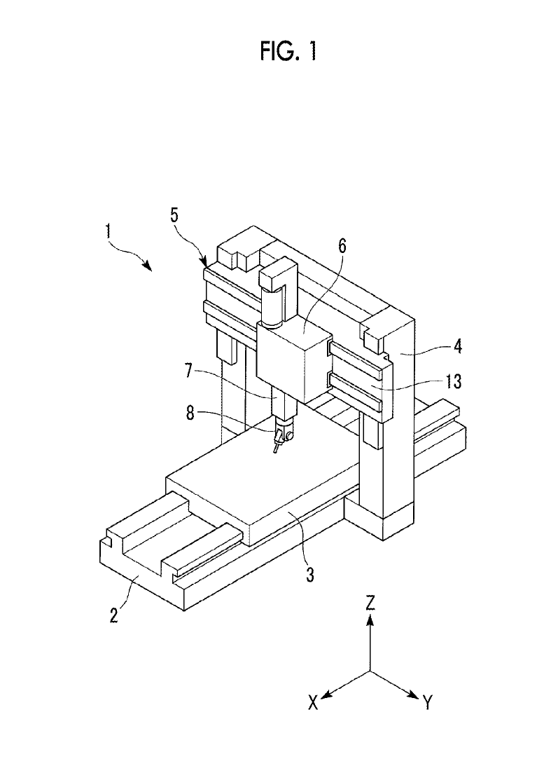

As shown in FIG. 1, a machine tool 1, to which a control method of a machine tool according to a first embodiment of the present invention is applied, is a gate type machine tool (machining target) which performs machining of a processing target, and includes a machine tool main body 5, a ram 7 which is supported by the machine tool main body 5 in a movable manner along a Z axis direction, and an attachment 8 which is mounted to be attached to and detached from a tip end portion of the ram 7.

The machine tool main body 5 includes a bed 2, a table 3 which is disposed on the bed 2 and is movable along an X axis direction, a gate type column 4 (supporting body) which is disposed over the table 3, and a saddle 6 which is movable on the column 4 along a Y axis direction, and can fix the processing target (not shown) onto the table 3.

A threaded portion (not shown) is formed in the table 3, a feeding shaft (not shown) provided along the X axis direction is screwed to the threaded portion, and a servo motor (not shown) is connected to the feeding shaft. The table 3 is moved and positioned in the X axis direction by rotary driving of the servo motor.

A cross rail 13 is attached to the column 4 in the Y axis direction, the saddle (driven portion) 6 is moved on the cross rail 13, and thus, the saddle 6 can be moved in the Y axis direction. The ram 7 is attached to the saddle 6 in a movable manner along the Z axis direction.

The attachment 8 which performs cutting or the like is attached to a tip end of the ram 7.

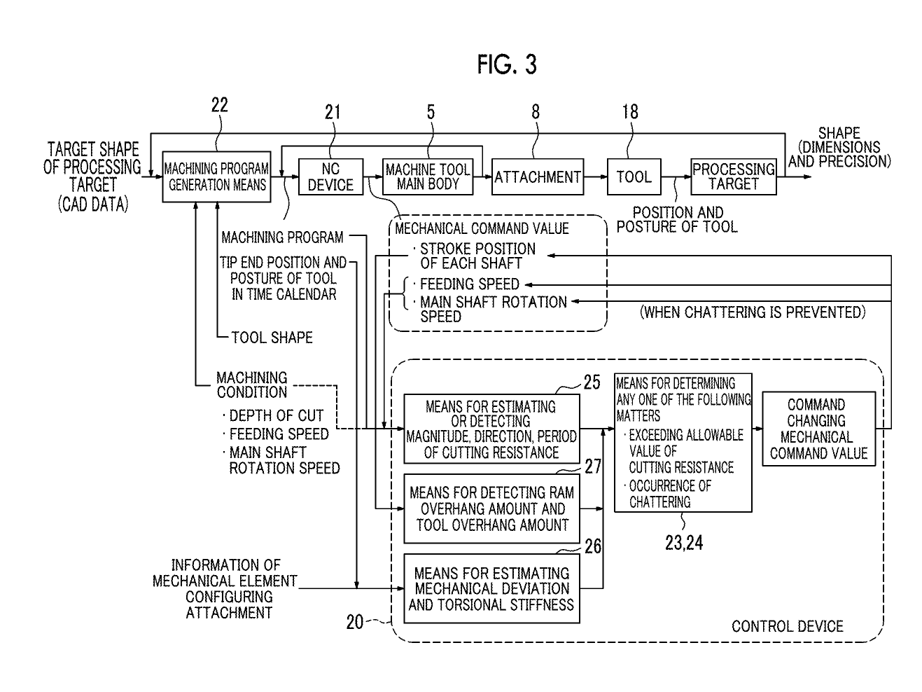

In addition, a numerical control of the machine tool 1 is performed by a NC device 21 (refer to FIG. 3).

The NC device 21 can perform a numerical control on the column 4, the saddle 6, the ram 7, a main shaft 9, or the like based on preset NC program data (machining data).

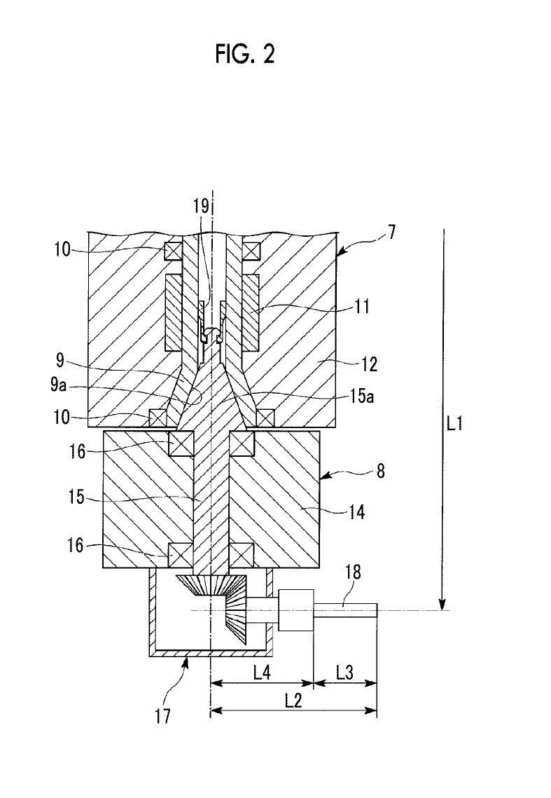

As shown in FIG. 2, the ram 7 includes a casing 12, the main shaft 9 which extends in a vertical direction in an inner portion of the casing 12 and is supported by the ram 7 in a drivable and rotatable manner, a bearing 10 which supports the main shaft 9 in a rotatable manner, and a spindle motor 11 which is disposed around the main shaft 9 and rotates the main shaft 9. At least a lower portion of the main shaft 9 is formed in a hollow shape, and an arbitrary attachment 8 can be mounted to the lower portion.

FIG. 2 shows an attachment, which rotates a rotation shaft of a tool referred to as a right angle head 90°, as an example of the attachment. The attachment 8 includes a transfer mechanism 17 and a tool 18 which is attached via the transfer mechanism 17, and the transfer mechanism 17 includes a casing 14, a driving shaft 15 which extends to an inner portion of the casing 14 in the vertical direction, a bearing 16 which supports the driving shaft 15 in a rotatable manner, and a bevel gear (bevel wheel) which is attached to a lower end of the driving shaft 15. For example, the tool 18 is an end mill or a drill.

The transfer mechanism 17 is configured of a bevel wheel such as a bevel gear, and thus, an axial direction of the tool 18 is orthogonal to axial directions of the main shaft 9 and the driving shaft 15.

An upper portion of the driving shaft 15 is formed in a tapered shape, and a lower portion of the main shaft 9 includes a tapered hole 9a corresponding to a tapered portion 15a of the driving shaft 15. In the attachment 8, in a state where the driving shaft 15 is inserted into the main shaft 9 from the lower portion, the upper end of the driving shaft 15 is grasped by a clamp 19 provided on the ram 7 side so as to be fixed. That is, the attachment 8 can be attached to and detached from the ram 7, and can be exchanged according to machining with respect to the processing target.

Next, an operation of the machine tool 1 of the present embodiment will be described.

As shown in a flowchart of FIG. 3, a target shape of the processing target is determined. That is, CAD data is prepared.

Next, a machining program is generated by a machining program generation means 22. The machining program is a program which describes a tip end position or a posture of the tool in a time calendar, and is generated based on a shape of the tool or machining conditions (depth of cut, feeding speed, and rotation speed of main shaft 9).

The generated machining program is sent to the NC device 21, and is converted to a mechanical command value in the NC device 21. The mechanical command value is sent to the machine tool main body 5, positions, postures, rotation speeds, or the like of the attachment 8 and the tool 18 are controlled, and thus, the processing target is machined.

Next, a control device 20 of the machine tool of the present embodiment will be described.

The control device 20 includes a cutting resistance adjustment function 23 which monitors excess in an allowable value of the cutting resistance, and a chattering prevention function 24 which prevents occurrence of chattering at the time of cutting. The control device 20 outputs a command which changes the mechanical command value received by the machine tool main body 5 from the NC device 21.

First, the cutting resistance adjustment function 23 will be described.

The cutting resistance adjustment function 23 is a function which estimates and calculates a parameter for calculating cutting resistance F using the following three means, and adjusts the cutting resistance F.

First means is means (cutting resistance estimation means 25) for estimating the cutting resistance F. Estimation logic of the cutting resistance F using the cutting resistance estimation means 25 will be described below.

In a case of lathe machining, when a diameter of the processing target is defined as d [mm], a feeding amount per one revolution of the tool is defined as f [mm/rev], a specific cutting resistance which is a parameter of a material of the processing target is defined as Ks [N/mm²], the cutting resistance F is calculated by the following Expression (1).

F[N]=d×f×Ks (1)

By replacing a diameter of the processing target in Expression (1) with an end mill diameter, the cutting resistance F can be estimated.

Second means is means (moment estimation means 26) for estimating cross-sectional secondary moment I of the ram 7.

The moment estimation means 26 calculates the cross-sectional secondary moment of the attachment 8 using information regarding mechanical elements configuring the attachment 8 including the shape of the attachment 8 stored in the NC device 21. At this time, it is assumed that the shape of the attachment 8 is a hollow columnar body. When an outer diameter of the columnar body is defined as D [mm] and an inner diameter is defined as d [mm], the cross-sectional secondary moment I is calculated by the following Expression (2).

I=π(D⁴−d⁴)/64 (2)

Third means is means (overhang amount detection means 27) for detecting a ram overhang amount L1.

The overhang amount estimation means is detected to be read from the command value of the NC device.

First, the cutting resistance adjustment function 23 calculates stress σ which is applied to the attachment 8 based on a value obtained from the above-described three means.

Moment M applied to the attachment 8 is calculated by the product of the cutting resistance F estimated by the cutting resistance estimation means 25 and the ram overhang amount L1 detected by the overhang amount detection means. If the cross-sectional secondary moment I estimated by the moment estimation means is used as a circular cross-sectional shape of a radius R of the attachment 8 of the columnar body, the stress σ applied to the attachment 8 is calculated by the following Expression (3).

$$\begin{matrix}σ = M \times R \text{/} I \\ = F \times L 1 \times R \text{/} I\end{matrix} \qquad ( 3 )$$

The cutting resistance adjustment function 23 adjusts the cutting resistance F or the ram overhang amount L1 so that the value of u is equal to or less than allowable stress σr of the attachment 8 calculated by the information regarding the mechanical elements configuring the attachment 8. That is, F or L1 is adjusted so that the following Expression (4) is satisfied.

F×L1×R/I<σr (4)

Specifically, the feeding amount f is decreased or the ram overhang amount L1 is decreased so that the cutting resistance F is decreased.

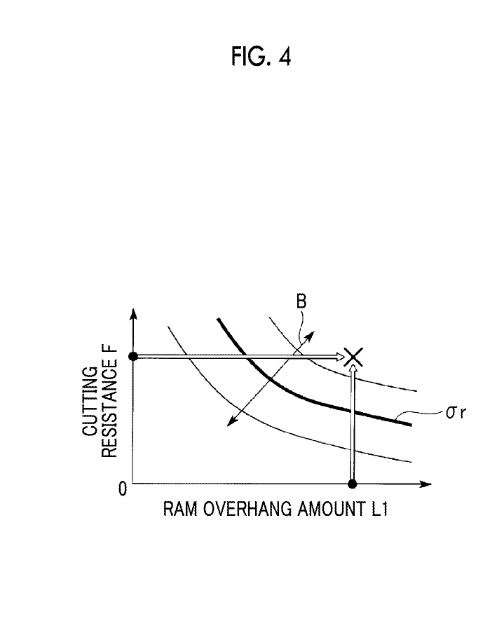

In addition, if Expression (4) is graphed, it becomes a graph showing a cutting resistance allowable value as shown in FIG. 4. That is, there is an inversely proportional relationship between the ram overhang amount L1 and the cutting resistance F.

For example, whether or not the value calculated by the ram overhang amount L1 and the cutting resistance F exceeds the allowable stress is determined by the graph.

Here, the graph is changed in a direction shown by arrow B of FIG. 4 according to the tool overhang amount L2. That is, when the tool overhang amount L2 is decreased, the allowable stress σr is increased, and when the tool overhang amount L2 is increased, the allowable stress σr is decreased.

In addition, as shown in FIG. 2, the tool overhang amount L2 can be obtained from a shape data L3 of the attachment 8 and an installation length L4 of the tool. The data and the information are held in the NC device.

Next, the chattering prevention function 24 will be described. The chattering prevention function 24 is a function which estimates a condition in which the chattering is generated by the frequency of the cutting resistance F and adjusts the rotation speed of the main shaft 9 to avoid such a condition.

When the rotation speed of the main shaft 9 is defined as S [rev/min], and the number of cutting teeth of the tool 18 is defined as T, frequency fm [Hz] of a cutting resistance can be calculated by the following Expression (5).

fm=S×T/60 (5)

For example, when the rotation speed of the main shaft 9 is set to 1000 rev/min and a milling cutter having sheets in the number of the cutter teeth is used, fm=1000×3/60=50 [Hz] is satisfied.

When resonance frequency fm of the cutting resistance F is equal to the resonance frequency of the attachment 8, the chattering prevention function 24 determines that the chattering occurs, and outputs a command which changes the machining conditions. The resonance frequency of the attachment 8 is calculated from the information regarding the mechanical elements configuring the attachment 8.

For example, when the resonance frequency of the attachment 8 is set to 50 Hz and the milling cutter having 3 sheets in the number of cutting teeth is rotated at 1000 rev/min, the chattering prevention function 24 determines that the chattering occurs.

When it is determined that the chattering occurs, for example, the chattering prevention function 24 increases the frequency fm of the cutting resistance by 10 Hz, and avoids the chattering. That is, the chattering prevention function outputs a command which causes the rotation speed of the main shaft 9 to be 1.2 times larger (=(50 Hz+10 Hz)/50 Hz).

According to the embodiment, when the stress σ applied to the attachment 8 is larger than the allowable stress σr, by using the cutting resistance adjustment function 23, the machining conditions are alleviated, the cutting resistance F is decreased, and thus, damage to the attachment 8 can be prevented. Moreover, since an overload state of the tool 18 is avoided by the alleviation of the machining conditions without stopping the machining, it is possible to shorten a machining time. In addition, since the control method is realized by simply changing the control method without additional mechanical portions, it is possible to prevent damage to the attachment 8 at a low cost.

Moreover, using the chattering prevention function 24, the rotation speed of the main shaft 9 is changed, the frequency of the cutting resistance F and the resonance frequency of the attachment 8 are different from each other, and thus, it is possible to prevent occurrence of the chattering by simply changing the control method.

### Second Embodiment

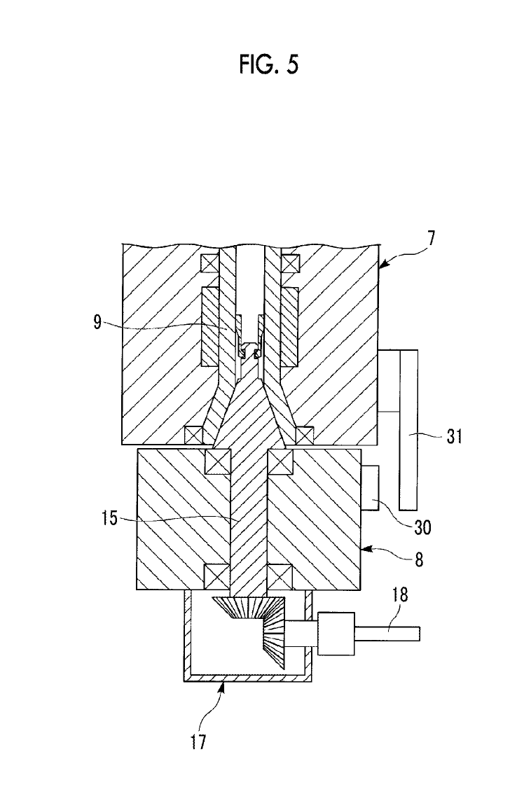

As shown in FIG. 5, in the present embodiment, as means for acquiring the shape information regarding the mechanical element configuring the attachment 8, an IC tag 30 (solid identification means) is attached to the attachment 8, and an IC tag reader 31 (solid identification information receiving unit) which receives information from the IC tag 30 is attached to the ram 7.

Information such as bending stiffness, torsional stiffness, or the natural frequency of the attachment 8, which is used to determine occurrence of the chattering or damage to the constitution element, is written to the IC tag 30. In addition, since mechanical deviation exists even in the same kind of attachment 8, with respect to a stiffness value or the like, each unique value is written.

The IC tag 30 and the IC tag reader 31 are positioned so that the IC tag reader 31 reads the information regarding the IC tag 30 when the attachment 8 is attached to the ram 7.

The operation of the embodiment will be described.

If the attachment 8 is attached to the ram 7, the information regarding the attachment 8 written to the IC tag 30 is read by the IC tag reader 31 and is sent to the NC device 21 and the control device 20. The information is sent to the moment estimation means 26 or the like.

The moment estimation means 26 calculates the cross-sectional secondary moment of the attachment 8 based on the information, the value is referred by the cutting resistance adjustment function 23, and thus, the cutting resistance is adjusted.

Alternatively, the resonance frequency of the attachment 8 is calculated based on the information, the value is referred by the chattering prevention function 24, and thus, the chattering is avoided.

According to the embodiment, the information regarding the mechanical element configuring the attachment 8 is input to the IC tag 30, the information is sent to the NC device 21 or the control device 20 by only attaching the attachment 8 to the ram 7, and thus, it is not necessary to switch the information regarding the attachment 8 by the operation of an operator (worker).

In addition, the solid identification means is not limited to the IC tag, and for example, may use a tag which communicates using magnetism or a marking such as a bar code.

### INDUSTRIAL APPLICABILITY

According to a control method of a machine tool, when stress applied to an attachment is larger than the allowable stress, machining conditions are alleviated, cutting resistance is decreased, and thus, damage to the attachment can be prevented.

### REFERENCE SIGNS LIST

1: machine tool

5: machine tool main body

7: ram

8: attachment

9: main shaft

15: driving shaft

18: tool

20: control device

21: NC device

30: IC tag (solid identification means)

31: IC tag reader (solid identification information receiving unit)

F: cutting resistance

I: cross-sectional secondary moment

L1: ram overhang amount

1. A control method of a machine tool which includes: a machine tool main body;
a ram which is supported with respect to the machine tool main body in a movable manner; a main shaft which is supported by the ram in a drivable and rotatable manner; an attachment which can be attached to and detached from a tip end portion of the ram and includes a driving shaft rotated according to rotation of the main shaft and a tool provided on the driving shaft; and a NC device which performs a numerical control based on machining data, and performs machining of a processing target, comprising:
a step of decreasing at least one of a ram overhang amount or a feeding amount when stress applied to the attachment is larger than allowable stress of the attachment based on a machining condition including a diameter, a depth of cut, and a feeding amount of the tool, and information including the ram overhang amount, a shape of the attachment, and a material of the processing target.

2. The control method of a machine tool according to claim 1, further comprising:
a step of decreasing at least one of the ram overhang amount or the feeding amount when the stress, which is applied to the attachment and calculated from a function among cutting resistance calculated from the product of the diameter of the tool, the feeding amount, and a specific cutting resistance of the material of the processing target, the ram overhang amount, and a cross-sectional secondary moment calculated by the shape of the attachment, is larger than the allowable stress of the attachment.

3. The control method of a machine tool according to claim 2, further comprising:
a step of changing a rotation speed of the main shaft when frequency of the cutting resistance calculated by the rotation speed of the main shaft and the number of cutting teeth of the tool is equal to resonance frequency of the attachment calculated by the shape of the attachment.

4. A machine tool comprising a control device which performs the control method of a machine tool according to claim 1.

5. The machine tool according to claim 4, further comprising:
solid identification means which is provided on the attachment and stores shape information regarding the attachment; and
solid identification information receiving unit which is provided on the ram and receives information from the solid identification means,
wherein the attachment is attached to the ram, and thus, the shape information regarding the attachment is sent to the control device and the NC device.

6. A machine tool comprising a control device which performs the control method of a machine tool according to claim 2.

7. A machine tool comprising a control device which performs the control method of a machine tool according to claim 3.
